(19) United States
(12) Patent Application Publication
(10) Pub. No.: US 2006/0140434 A1
(43) Pub. Date: Jun. 29, 2006

(54) FABRICATING METHOD OF EARPHONE

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/906,043

(22) Filed: Feb. 1, 2005

(30) Foreign Application Priority Data
Dec. 29, 2004 (TW) 93141077

(51) Int. Cl. H04R 25/00

(52) U.S. Cl. 381/380; 381/370; 381/328

(57) ABSTRACT

A fabricating method of earphone is provided. A housing is provided first in this method. The housing has a holding space, an entrance-end and a corresponding output-end. The housing has a stopping-portion in the output-end. Then, a micro speaker is disposed into the holding space from the entrance-end of the housing and against the stopping-portion. Afterward, a cap is assembled to the entrance-end of the housing such that the micro speaker is fixed in the holding space by the cap and the stopping-portion. The assembling time can be shortened with this fabricating method of earphone.

### CROSS-REFERENCE TO RELATED APPLICATION

This application claims the priority benefit of Taiwan application serial no. 93141077, filed Dec. 29, 2004.

### BACKGROUND OF THE INVENTION

1. Field of the Invention

The present invention relates to a fabricating method of electronic product, and more particularly, to a fabricating method of earphone.

2. Description of the Related Art

Along with continuous progress of new technology, electronic product is intended to be developed as thinner and lighter, such that the mini electronic product such as radio or walkman can be used by people anytime and anywhere. In addition, since personal digital product is more popular now, the mini electronic product such as MP3 walkman, mobile phone, PDA (Personal Digital Assistant), or laptop (also known as notebook) computer becomes an inevitable tool in our daily life. Moreover, the mobile phone supporting both radio reception and MP3 playing functions is also available in market now.

Regardless of which type of electronic product it is, in order to support the user enjoying the audio information provided by the electronic product without disturbing others, a earphone has become a mandatory accessory of the electronic product. In addition, the earphone also provides a better transmission of sound for listener, such that listener can clearly hear and understand the content of sound, so as to avoid the problem of unclear sound when it is transmitted via the atmosphere. Even when the user is on movement, for example, when the user is engaging in sporting, driving, aggressive activities or under a noisy environment, the reception and quality of sound are not impact.

FIG. 1A and FIG. 1B schematically show a conventional earphone before and after it is assembled, respectively. Referring to both FIG. 1A and FIG. 1B, a typical earphone 100 mainly comprises a housing 110 and a micro speaker 130. In order to drive the micro speaker 130, the micro speaker 130 is normally connected with a wire 150. Therefore, in the prior art, the earphone 100 is assembled by inserting the wire 150 through the whole housing 110 first, and then electrically coupling the wire 150 to the micro speaker 130. Alternatively, the conventional earphone 100 may be assembled by electrically coupling the wire 150 to the micro speaker 130 first, and then inserting the wire 150 through the whole housing 110. No matter of the earphone is assembled by which type of assembly mentioned above, the step of inserting the wire 150 through the whole housing 110 is a very time consuming work.

In addition, referring to FIG. 1B, after the micro speaker 130 and the housing 110 are assembled, an adhesive 50 is commonly used to bind the micro speaker 130 and the housing 110 together. Such binding method is time consuming and is notorious in its poor adhesive effect. Accordingly, the problem of the micro speaker 130 departing from the housing 110 is commonly happened after it is used for a certain period of time.

### SUMMARY OF THE INVENTION

Therefore, it is an object of the present invention to provide a fabricating method of earphone for reducing earphone assembling time and earphone manufacturing cost.

The present invention provides a fabricating method of earphone. Wherein, a housing is provided first in this method. The housing has a holding space, an entrance-end and a corresponding output-end. The housing has a stopping-portion in the output-end. Then, a micro speaker is disposed into the holding space from the entrance-end of the housing and against the stopping-portion. Afterward, a cap is assembled to the entrance-end of the housing such that the micro speaker is fixed in the holding space by the cap and the stopping-portion. The assembling time can be shortened with this fabricating method of earphone.

In the fabricating method of earphone, a sound-collection tube could be further assembled to the output-end of the housing after the cap is assembled. In addition, an ear cushion could be further assembled to the sound-collection tube after the sound-collection tube is assembled. Alternatively, the ear cushion could be further assembled to the output-end of the housing after the cap is assembled. In addition, the housing could be formed by plastic injection molding, casting, lathe processing, or other method. After the micro speaker is disposed into the holding space, a dust filter could be further assembled to the output-end of the housing.

In another embodiment of the present invention, the output-end of the housing could be further extended outward with a sound-collection tube portion. In this case, an ear cushion could be further assembled to the sound-collection tube portion of the housing after the cap is assembled. In addition, a dust filter could be further assembled to the sound-collection tube portion of the housing after the micro speaker is disposed into the holding space.

In summary, the fabricating method of earphone provided by the present invention directly disposed the micro speaker into the holding space of the housing, and the micro speaker is fixed in the holding space after the cap is assembled. Therefore, the fabricating method of earphone provided by the present invention significantly reduces earphone assembling time and manufacturing cost.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A and FIG. 1B schematically show a conventional earphone before and after it is assembled, respectively.

FIG. 2A schematically shows a explosive view of all components in the fabricating method of earphone according to an embodiment of the present invention before they are assembled.

FIG. 2B schematically shows a sectional diagram of the earphone of FIG. 2A after it is assembled.

FIG. 3 schematically shows a sectional diagram of another earphone fabricated with the fabricating method of earphone according to an embodiment of the present invention.

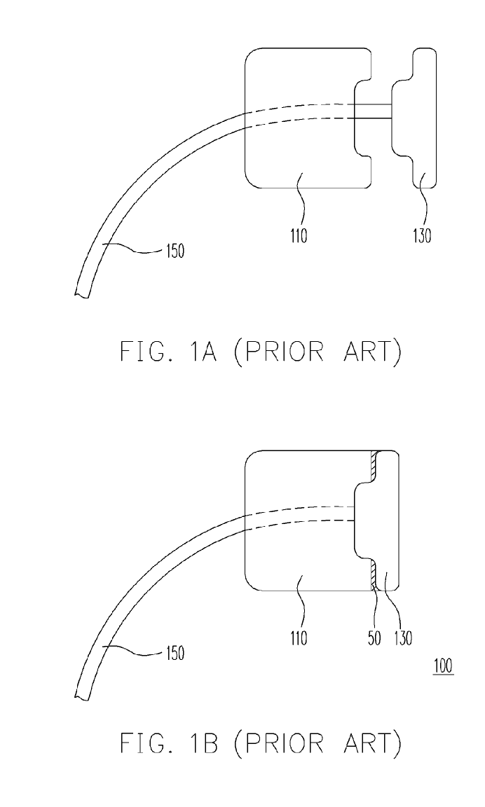

### DESCRIPTION OF THE PREFERRED EMBODIMENTS

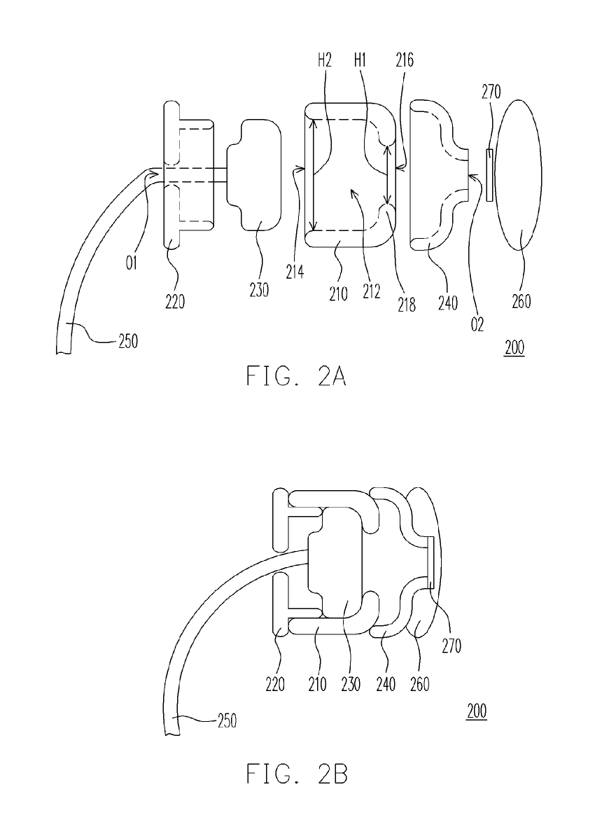

FIG. 2A schematically shows a explosive view of all components in the fabricating method of earphone according to an embodiment of the present invention before they are assembled, and FIG. 2B schematically shows a sectional diagram of the earphone of FIG. 2A after it is assembled.

Referring to both FIG. 2A and FIG. 2B, in the fabricating method of earphone provided by the present invention, a housing 210 is first provided. Wherein, the housing 210 may like a cylinder, and there is a holding space 212 inside the housing 210. The housing 210 has an entrance-end 214 and a corresponding output-end 216, and the holding space 212 is open to outside on the entrance-end 214 and the output-end 216. In addition, the housing 210 has a stopping-portion 218 in the output-end 216. Since the stopping-portion 218 is extended inward from the peripheral of the housing 210, the opening size H1 of the output-end 216 is smaller than the opening size H2 of the entrance-end 214. In addition, the housing 210 could be formed by plastic injection molding with typical injection machine, or formed by casting with metal materials. Of course, the housing 210 may be formed by lathe processing or other method. Since the housing 210 is suitable for mass production, the manufacturing cost is reduced.

Then, a micro speaker 230 is disposed into the holding space 212 from the entrance-end 214 of the housing 210 and against the stopping-portion 218, such that the micro speaker 230 is positioned in the holding space 212. The micro speaker 230 may comprise a speaker vibration system and an magnetic loop, where the speaker vibration system may be a vibration film with a coil. In this step, the opening size H2 on the entrance-end 214 of the housing 210 in the holding space 212 may be designed as roughly matched with the size of the micro speaker 230. Therefore, it is easy to dispose the micro speaker 230 into the holding space 212 from the entrance-end 214 of the housing 210. In addition, the opening size H1 on the output-end 216 of the housing 210 in the holding space 212 should be designed as smaller than the size of the micro speaker 230, such that the micro speaker 230 can be fixed in the holding space 212 by the stopping-portion 218 after it is disposed into the holding space 212 from the entrance-end 214 of the housing 210. Since the step of fixing the micro speaker 230 in the holding space 212 is very simple, the assembling time is reduced. In addition, if this step is performed by automatic equipment, the assembling time and manufacturing cost are significantly reduced.

Afterwards, a cap 220 is assembled to the entrance-end 214 of the housing 210, such that the micro speaker 230 is fixed in the holding space 212 by the cap 220 and the stopping-portion 218. Wherein, the cap 220 may has an opening O1, which is used by a wire 250 for connecting to the micro speaker 230. The opening O1 is not necessarily limited to locate on the center of the cap 220 only, it may locate on the edge of the cap 220, such that the possibility of the wire 250 being broken by the user is reduced. In addition, the cap 220 is preferably designed as tightly against the micro speaker 230, so as to prevent the micro speaker 230 from moving back and forth in the holding space 212. However, it is not necessarily to limit the cap 220 must against the micro speaker 230. In addition, the cap 220 and the housing 210 can be fixed with a protruding structure and a concave structure that are physically matched with each other, or fixed with an adhesive. Of course, the cap 220 and the housing 210 can be fixed with other appropriate fixing method. Meanwhile, the assembly of the earphone 200 is roughly completed.

In addition, in the fabricating method of earphone provided by the present embodiment, a sound-collection tube 240 could be further assembled to the output-end 216 of the housing 210 after the cap 220 is assembled. The sound-collection tube 240 is used to concentrate the direction of sound wave provided by the micro speaker 230, so as to improve the sound quality of the micro speaker 230.

Furthermore, in the fabricating method of earphone provided by the present embodiment, an ear cushion 260 could be further assembled to the sound-collection tube 240 after the sound-collection tube 240 is assembled. The ear cushion 260 is typically made of rubber or sponge material, and the major purpose of the ear cushion 260 is to reduce the uncomfortable feeling of the user by appropriately disposed it into user's ears. Moreover, the ear cushion 260 is also good in properly isolating external noise.

In addition, a dust filter 270 could be further disposed to the output-end 216 of the housing 210 or an opening O2 of the sound-collection tube 240, so as to prevent external dust from falling into the sound-collection tube 240 or the housing 210.

Of course, the sound-collection tube 240 and the ear cushion 260 are optional, and the ear cushion 260 is not necessarily limited to be disposed on the sound-collection tube 240, the ear cushion 260 may be directly disposed on the output-end 216 of the housing 210 after the cap 220 is assembled.

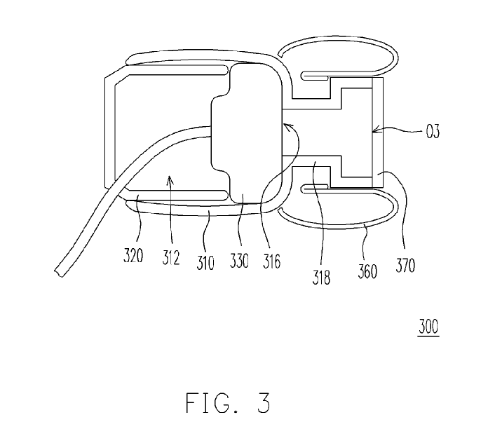

FIG. 3 schematically shows a sectional diagram of another earphone fabricated with the fabricating method of earphone according to an embodiment of the present invention. Referring to FIG. 3, the housing 310 of the earphone 300 provided by the present embodiment could be an integrated component directly made by cutting some metal material. The housing 310 is roughly same as the housing 210 of FIG. 2B except the output-end 316 of the housing 310 is further extended outward with a sound-collection tube portion 318. In other words, a sound-collection tube portion 318 is embedded in the body of the housing 310, such that the step of assembling the sound-collection tube is eliminated.

In addition, similar to the earphone 200 of FIG. 2B, after a micro speaker 330 is disposed into the holding space 312 and a cap 320 is assembled into the housing 310 in order to fasten the micro speaker 330, a dust filter 370 could be further assembled to an opening 03 of the sound-collection tube portion 318 in the housing 310. Moreover, an ear cushion 360 could be further assembled to the sound-collection tube portion 318 of the housing 310. Wherein, the ear cushion 360 is made of rubber or other appropriate materials, and the shape of the ear cushion 360 is fit with the housing 310, so as to prevent the ear cushion 360 from detaching.

In the fabricating method of earphone provided by the present invention, the micro speaker is directly disposed into the holding space of the housing, and the micro speaker is fixed in the holding space by the cap. Therefore, the fabricating method of earphone provided by the present invention is good in reducing the time spending in inserting the wire into the components, and is also suitable for assembling with automatic equipment. In addition, the cap and the housing could be directly matched with each other by appropriately designing the method for binding the cap and the housing without having to use additional adhesive or other fixing element, such that the micro speaker is tightly fixed in the housing. In summary, the fabricating method of earphone provided by the present invention dose not only significantly reduce the earphone assembling time, but also reduce earphone manufacturing cost, and the earphone yield rate is further improved.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A fabricating method of earphone, comprising:
providing a housing having a holding space, and the housing has an entrance-end and a corresponding output-end, and a stopping-portion in the output-end;
disposing a micro speaker into the holding space from the entrance-end of the housing, and having the micro speaker against the stopping-portion; and
assembling a cap to the entrance-end of the housing, such that the micro speaker is fixed in the holding space by the cap and the stopping-portion.

2. The fabricating method of earphone of claim 1, wherein a sound-collection tube is further assembled to the output-end of the housing after the cap is assembled.

3. The fabricating method of earphone of claim 2, wherein an ear cushion is further assembled to the sound-collection tube after the sound-collection tube is assembled.

4. The fabricating method of earphone of claim 1, wherein an ear cushion is further assembled to the output-end of the housing after the cap is assembled.

5. The fabricating method of earphone of claim 1, wherein the housing is formed by plastic injection molding, casting, or lathe processing.

6. The fabricating method of earphone of claim 1, wherein a dust filter is further assembled to the output-end of the housing after the micro speaker is disposed into the holding space.

7. The fabricating method of earphone of claim 1, wherein the output-end of the housing is further extended outward with a sound-collection tube portion.

8. The fabricating method of earphone of claim 7, wherein an ear cushion is further assembled to the sound-collection tube portion of the housing after the cap is assembled.

9. The fabricating method of earphone of claim 7, wherein a dust filter is further assembled to the sound-collection tube portion of the housing after the micro speaker is disposed into the holding space.
